(19) United States
(12) Patent Application Publication
(10) Pub. No.: US 2008/0013701 A1
(43) Pub. Date: Jan. 17, 2008

(54) Voting And Multi-Media Actionable Messaging Services For Mobile Social Networks

(76) Inventors: William J. Barhydt, Los Gatos, CA (US); Sanjeev Bhalla, Sunnyvale, CA (US); Michael Cartabiano, Redondo Beach, CA (US); Julian Hardy, Putney (GB); Jia Wen Su, Sunnyvale, CA (US); Woon Shing Chan, Monterey Park, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/696,711

(22) Filed: Apr. 4, 2007

Related U.S. Application Data
(60) Provisional application No. 60/744,220, filed on Apr. 4, 2006.

(51) Int. Cl. H04M 11/00

(52) U.S. Cl. 379/92.02

(57) ABSTRACT

Provided herein are systems and methods that provide community based voting and/or actionable multi-media messaging in a social network. In an embodiment, actionable multi-media messaging is provided, in which the user receives a message comprising an actionable item that the user can act on. The actionable item can be, e.g., to purchase an item, to vote on a ballot, or other actions that can be taken by the user. In another embodiment, community based voting is provided, in which a user receives a message comprising a voting ballot. In this embodiment, the user can vote on the ballot, and publish his/her vote to his/her social network, e.g., to express his/her likes and dislikes. The user can also forward the ballot to other users in his/her social network, and view how other individual users in his/her the social network have voted.

### RELATED APPLICATION INFORMATION

This application claims the benefit of U.S. Provisional Application Ser. No. 60/744,220, filed on Apr. 4, 2006.

### FIELD OF THE INVENTION

The invention relates to mobile social networks, and more particularly to applications that provide community voting and/or actionable multi-media messaging in mobile social networks.

### BACKGROUND INFORMATION

Voting by sending a Short Text Message (SMS) from a mobile device has become highly popular in recent years. Allowing users to vote for their favorite singer or song is a way to get an audience hooked onto popular TV content such as Fox TV's American Idol. These traditional mobile voting applications involve receiving votes, computing the overall voting results and then publicly announcing the results, typically through a different medium such as TV. These voting applications serve to draw the audience in and create a degree of mystery and aura around the content that is subject to voting.

However, these applications do not leverage the social dynamics of voting. In certain contexts, where a social network exists and where user profiles are known to the system, voting can be a social phenomena and leveraging this can lead to significant improvements in user experience and resultant stickiness to the service.

Similarly sending Short Text Messages (SMS) and Multi-Media Messages (MMS) has been very popular in recent years. These messages convey a text message, an image, audio or video or a combination of multiple media types. However, the only actions that the user can take on these messages is to read them, forward them or reply to them.

### SUMMARY

Provided herein are systems and methods that provide community based voting and/or actionable multi-media messaging in a social network.

In an embodiment, a system stores users profiles, wherein each user profile includes attributes of the corresponding user. The user attributes may include the user's wireless operator and phone model, the user's age and gender, and previous actions taken by the user, e.g., songs purchased by the user. Users in the system are interconnected in social networks. In one embodiment, each user's profile comprises a list of other users with whom the user has formed buddy relationships. The user is connected to the buddies in his/her list, forming a social network. In addition, the user may be indirectly connected to other users, e.g., through his/her buddies, to form larger social networks.

In an embodiment, actionable multi-media messaging is provided, in which the user receives a message comprising an actionable item that the user can act on. The actionable item can be, e.g., to purchase an item, to vote on a ballot, or other actions that can be taken by the user. When the user acts on the actionable item, e.g., purchases an item, his/her mobile phone/handset sends a message to a backend server indicating the action taken by the user. The backend server then acts in response to the action taken by the user. For example, if the action taken by the user is to purchase a ringtone, then the backend server completes the transaction. Actionable multi-media messages are advantageous over traditional messages because they can result in a user taking action, e.g. subscribing to an offer, or purchasing an item, or joining a network, as a result of receiving and acting on a message.

In another embodiment, community based voting is provided, in which a user receives a message comprising a voting ballot. In this embodiment, the user can vote on the ballot, and publish his/her vote to his/her social network, e.g., to express his/her likes and dislikes. The user can also forward the ballot to other users in his/her social network, and view how other individual users in his/her social network have voted. This community based voting stimulates activity in the social network, and leverages the social dynamics of voting in the social network.

In another embodiment, a user's profile is used to determine which actionable multi-media messages the user is more likely to act on, or which voting ballots the user is more likely to vote on. This allows actionable multi-media messages and voting ballots to be targeted to specific users.

Other systems, methods, features and advantages of the invention will be or will become apparent to one with skill in the art upon examination of the following figures and detailed description.

### BRIEF DESCRIPTION OF THE FIGURES

FIG. 1 shows a system architecture for providing a social network according to an embodiment of the present invention.

FIG. 2 shows an example of a social network comprising interconnected buddies.

FIG. 3 shows an example of code for a message with an actionable item according to an embodiment of the invention.

### DETAILED DESCRIPTION

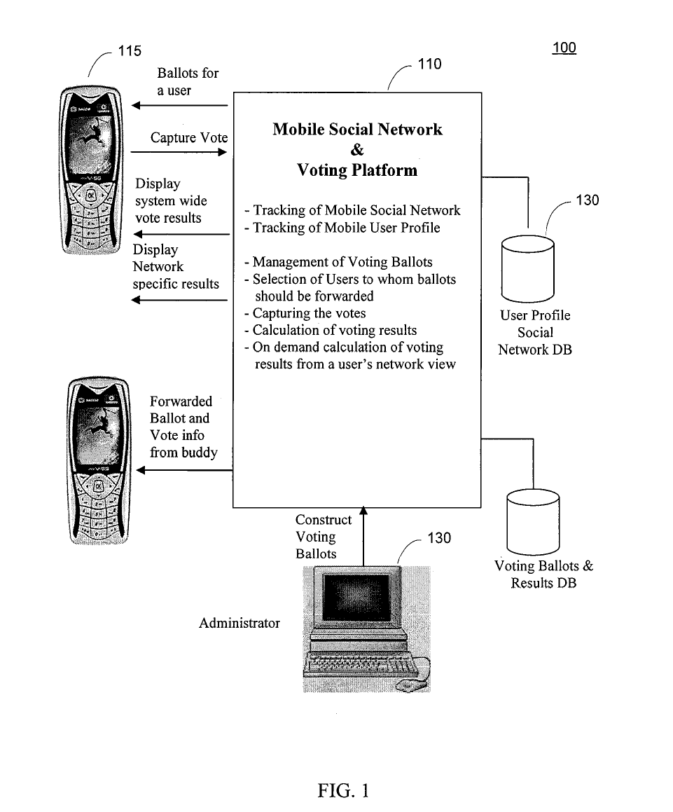

FIG. 1 shows a system architecture 100 for providing a social network according to an embodiment of the present invention. The system 100 includes a User Profile and Mobile Social Network Platform 1 10 that can connect to users' mobile phone/handsets 115 via wireless links. The system 100 has knowledge of users that are registered with the system 100. Users have profiles stored on a database 120 of the system 100, in which each user profile contains a set of attributes for the corresponding user. These attributes may either be system determined or may be entered by the user. For example, the following exemplary user attributes can be stored in the system:

a) Wireless Operator—this identifies the Wireless Operator, e.g., Verizon, used by the user and is determined automatically by the system during registration of the user.

b) Phone model—this identifies the type of mobile phone/handset used by the user and is determined automatically by the system during registration of the user and may be changed later.

c) Applications used—this identifies applications that the user has used on his/her mobile phone/handset, and is determined automatically by the system over time as the user uses multiple applications

d) Age—this is an optional attribute that is input by the user

e) Gender—this is an optional attribute that is input by the user

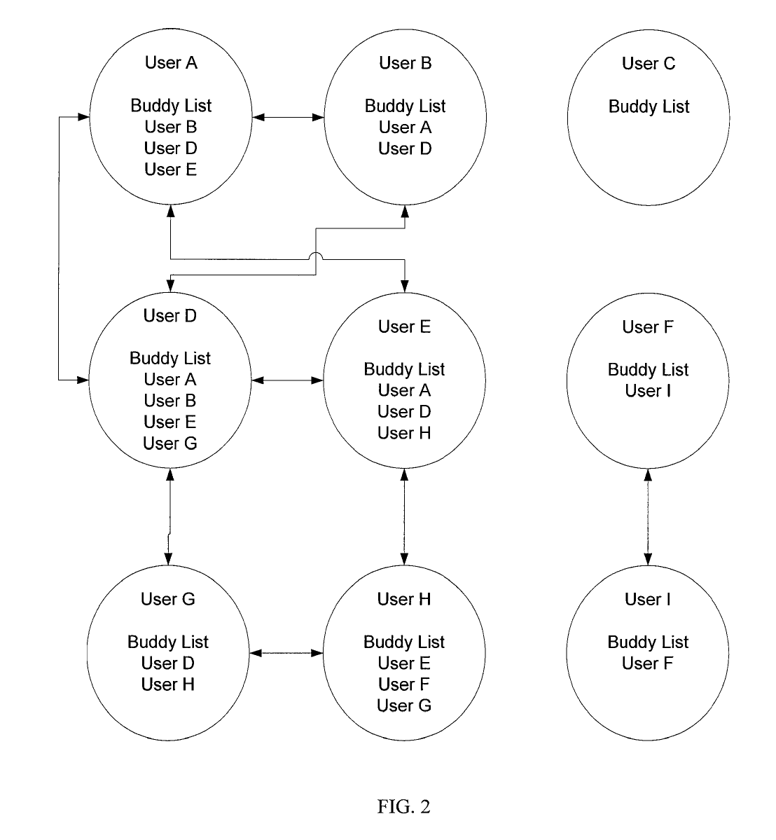

A user profile also includes information about the user's mobile network. The user profile contains a list of users with whom a buddy relationship has been established. In one embodiment, the buddy relationship is assumed to be reciprocal, i.e., if User A has Users B as his/her buddy then User B also has User A as his/her buddy. A buddy relation may be formed, e.g., by having User A request to put on User B's buddy list and having User B accept the request. Graphically, this buddy relationship can be illustrated as a buddy connection between User A and User B. FIG. 2 shows an example of social networks. A user in a network may have any number of buddies from zero up to a maximum of the total number of users in the system. A user is connected to a number of users, some through direct connections and some through indirect connections. There may be different isolated networks which do not share any links between them. This graph of interconnected users, all of whom communicate with each other using their mobile phones, constitutes the mobile social network.

In the example shown in FIG. 2, User A is directly connected to Users B, D, and E. These users make up User A's immediate buddies. User A is indirectly connected to User G through User D, and is indirectly connected to User H through User E. Users A, B, D, E, G, and H form a social network, and Users F and I form a social network that is isolated from the social network of Users A, B, D, E, G, and H. User C has no buddies in his/her buddy list. A user's network may have different levels of users, in which the first level contains buddies that are directly connected to the user, the second level contains users indirectly connected to the user through one other user, and so on.

Multi-Media Actionable Messaging

Provided herein are a class of applications where knowledge of a user's profile is used to deliver to a set of multi-media actionable messages to the user. These messages may be in multimedia form and include text, images, audio, video or any combination thereof. In addition, these messages may have actionable items that can be selected by the user. For example, if a user receives a message with a voting ballot, then the user can act on the ballot by voting.

Once a user selects an actionable item, a message is sent to the backend server to effect that action. For example, if the actionable item is a voting ballot and the user votes on the ballot, then a message with the user's vote is sent to the backend server to registers the user's vote.

If the social network has a Rewards and Loyalty program, then Reward points can be offered to users to motivate forwarding of such messaging as well as acting on them.

In the mobile social network, messages may flow back and forth through the network. These messages may be initiated by the system or initiated by the users and may also pass from one user to another. Each message may include text, image, audio, video or other type of data.

In the mobile world, standards for SMS (Short Message Service) and MMS (Multi-Media Message Service) exist. These standards allow either simple text messages or multi-media messages (image, audio, video, rich text) to be exchanged between mobile handsets. Embodiments of the invention provide for the exchange of messages between system and handset and between handsets that, in addition to containing multi-media content, can also contain actionable items for the user.

For example, on a message regarding singer Madonna, the message may contain actionable items to buy ringtones from her songs. As another example, on a message regarding the Rolling Stones, the actionable item may be to buy a ticket for one of their concerts.

In one embodiment, each message is encoded as a MIME (Multipurpose Internet Mail Extensions) multi-part message. Each part of the message may contain different content, e.g. text, image, audio, or video A separate type of content is created for actionable message content. The actionable message content uses a subset of XHTML to encode the screen layout including actionable items. Actionable items can be represented as menu items on the mobile handset screen when the actionable content is rendered. The presentation may vary and is controlled by the tags present in the actionable item page.

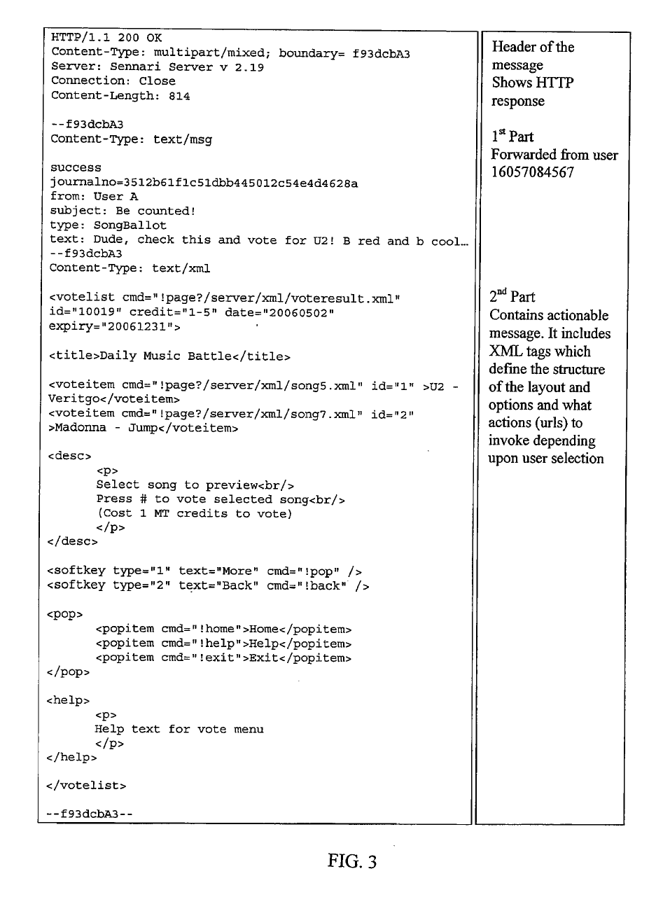

An example of code for an actionable message is shown in FIG. 3. The message in this example is sent from User A to a recipient. The message includes two parts. The first part is a text message which includes a message from User A: “Dude, check this and vote for U2! B red and b cool . . . ” The second part includes an actionable component which in this example shows the user a list of two songs, allows the user to preview the two songs, and to vote on which one of the two songs he/she likes better. When the user votes, a message with the user's vote is sent to the backend server.

In order to display the messages, each mobile handset must also have an application that interprets and displays the messages. The application interprets the MIME message, displays all its parts appropriately and in the sequence displays the actionable item page. When the user initiates the actionable item the application sends a request to the backend server to fulfill the request. The backend server is specified by a URL in the request. The context of the request (the phone number from which the request is sent, the application making the request and the item being acted on) are all sent to the server so that appropriate actions can be taken. Based on the type of action chosen, the backend performs appropriate business logic to fulfill the request.

Messages can flow between users or between a system and a user. When messages flow from a system to a user, the profile of the users, and system's tracking of activity is used to determine what actionable actions should be attached to which messages.

The system maintains a database of each type of actionable event. For example, purchases of ringtones and concert tickets, votes, along with other previous actions by a user determines the actionable event most likely to be attractive to the user based on the user's profile and history. The message with the actionable event is viewed by the user and can be acted upon by the user. In addition, the user may forward the message with the actionable event to his/her buddy network. As an example, if a user has recently purchased a ringtone, then purchase of another ring tone may not be likely. On the other hand, if the user purchased the ringtone a month ago then perhaps the user can be enticed to buy a new one based on a recent top hit single. The system uses such heuristics to determine the right actionable event to attach to each message as the message flows through the system.

The system also tracks statistics both at the system level of which actions have had a higher degree of success and at a given user level to influence which actionable events in the future will likely result in action from the user.

Voting in a Mobile Social Network

Provided herein are a class of mobile applications that leverage knowledge of user profiles as well as mobile social interconnected networks, and use mobile multi-media actionable messages to stimulate activity within the social network.

Traditionally, voting is a secret process, in which a given user's vote is only known to that user. Aggregated results of the voting are made visible to everyone but not the individual votes. However, voting is used in many contexts where it becomes an act of expressing one's likes and dislikes. Voting also serves to excite the social group into action. In such contexts, combining voting with social networks can further simulate activity of the users in the network and hence generate more value for the social network and application provider.

To take advantage of voting in a social network, system administrators create a set of voting ballots. The voting ballots may be designed to excite the social network into activity, or may be designed to solicit some information. Based on user profiles, voting ballots that would be of interest to users are forwarded to them. Users may choose to vote on one or more of the ballots that are forwarded to them. They may also forward the ballots to other users whom they think would be interested in the ballots.

Users vote on a ballot and can instantly see the current results of the voting. They can publish their vote to their social network. They also can see how their affiliated network of buddies has voted on the ballot. Results of each level in their specific connected network may also be shown. The user may also canvass their connected network to vote for their cause.

Voting can also be used to categorize users into groups. People who vote alike often have similar tastes and their affinity may extend beyond the topics being voted. This information can be used to introduce new people to each other and results in formation of new buddy relationships.

These features result in a voting dynamic in a social network setting that is different from individual one person voting. In addition, if the social network has a Reward and Loyalty program, then Rewards can be offered to users to participate in voting.

The system 100 tracks a user profile which is made up of a set of user attributes. Some user attributes, e.g. phone model, are determined by the system. Other user attributes, such as age, gender, zip code, are indicated by the user during application registration.

The system 100 also maintains buddy information for a user by maintaining a list of users with which the user shares buddy relationships. Buddy relationships are established through a mutual acceptance process, in which both sides want to establish a buddy relationship. The above information may be stored in a relational database management system. A mobile social voting will now be described. The mobile social voting process includes the following steps:

1. Creation of the voting ballots by a System Administrator.

2. Based on the profile of the users, forwarding the ballots to those users who are deemed to act on the ballot.

3. Capturing user vote.

4. Display current results of the vote.

5. Review the voting results of a user's buddy social network.

6. Users forward the ballot and their vote to their network as well as canvass their network for support for a particular cause.

The steps will now be described in greater detail below.

1. Creation of Voting Ballots

A system administrator creates voting ballots, e.g., from an administrator computer 130. These ballots may solicit community opinion on any topic that is pertinent to the application and of interest to the community. For example, for a music community application, a ballot may pit two hot songs against each other by having users vote on their favorite of the two songs. The ballot may be in the form of a multi-media message and include audio of the songs, information about the singers, as well as other background information relevant to the user experience in reviewing the ballot.

Ballots have a start date and an expiration date which designates the duration during which they may be voted on. The ballots are stored as multi-media messages with links to the media files on the backend platform. The media files (audio, images) are stored as links and loaded on demand from the client. Ballots also have properties which the system can compare with a user profile to determine which ballots would be of interest to a user.

2. Forwarding Ballots to Users

The system uses user profile information as well as properties of the ballots set up by the administrator to determine which ballots to forward to which users. The user profile is setup by the user as well as determined automatically by the system based on the usage or non-usage by the user. A user profile includes basic facts such as the age, the gender, zip code, the phone type and the wireless operator of the user. For different types of applications, the profile may also includes application specific information. For a music application, it may indicate interest in different types of music, e.g., is the user interested in country music? For a promotions and coupon application it may include interest in different retail stores, e.g., is the user interested in BestBuy, Sears or Kmart?

In addition to the user provided information, the system also determines the user's interests through the user's activities. For example, the user profile may indicate an interest in the singer 50 Cent if the user has listened to songs by that signer. As another example, the user profile may indicate a dislike for Jazz if the user had been given and chosen not to vote on ballots regarding Jazz, even though the user log in and viewed the ballots. All of these actions or inactions contribute in developing the user profile.

The system also determines the profile by using buddy information and using the profile of a user's buddies to influence the user profile. If the network that a user is connected to has a significant interest in one particular direction then it is highly likely that the user himself has an interest in that direction. For example, if the network that User A is connected to has many users expressing an interest in Rap songs, then it is likely that User A would be interested in Rap songs even if he/she has not explicitly expressed an interest in Rap songs.

When a ballot is entered into the system, the administrator sets various attributes for the ballot. These attributes of the ballot are combined with the user profile information and user's usage information to determine which users to target the ballot to. Examples of ballot attributes include the follow:

a) Category, which could be Music, Political, Shopping, etc.

b) Sub-category, which could be Music Genre, Retail stores, etc.

c) Age targeting, if the vote has to be targeted to specific age groups.

d) zipcode targeting, if the vote has to be targeted to specific locations.

e) Purchase targeting, if the vote has to be targeted only to users who have or have not purchased anything from the system .

In one embodiment, the ballot may be forwarded to all users of the system. The ballot is deposited into the user's account on the backend system.

3. Capturing User Vote

When a user uses the mobile application and logs into the system, they are presented with all messages for them. Because the space on a handset is limited, the messages are organized into different categories—messages from their buddies, system actionable alerts, ballots for votes, etc.

A user may chose to browse a ballot that has been sent to him/her. The user may also indicate that he/she is not interested in receiving ballots of that class. If a user is interested, then the user can browse the ballot and vote on it.

When a user votes on a ballot, the user can also indicate whether he/she wants his/her vote to be published to his/her buddy network. If the user decides to publish the vote to his/her network, his/her buddies can see how the user voted. If not, then the vote is private and no indication is given to the buddies whether the user has already voted or not.

4. Display Instantaneous Vote Results

Once a user has voted on a ballot, he/she is shown the current status of the voting for that ballot.

5. Display Vote Results for Social Network

The user may also review the voting results of his/her social network. As described above, each user is connected to a set of buddies, who are in turn connected to another set of buddies. Each of these sets of buddies may be overlapping. Following the graph from a user one can construct the set of users who are one step removed from the user (their immediate buddies), who are removed two steps from the user, and so on.

Voting results for each level are constructed on the fly and displayed to the user.

In addition, a user may see the actual individual votes by his/her immediate level of buddies, and not just summary information of the total votes. A particular buddy's vote can be viewed if that buddy allowed his/her vote to be public to his/her immediate network. This allows the user to compare his/her vote to those of his/her immediate and connected peers.

Such voting interaction within the social network results in increased usage of the service by users and increased SMS and Mobile Instant Messaging activity to discuss the vote.

6. Forwarding Ballot and Vote to Buddy Network

Users may choose to have their vote be visible to their immediate buddies. This is the default setting in the system, though it can be changed if a user does not want to make their vote visible.

Users may also forward the voting ballots along with their vote and canvass their network for votes in favor of their cause.

When a user forwards a ballot, he/she attaches a forwarding message and sends it to one or more of his/her buddies. A buddy receives the ballot on his/her messages and may chose to review and vote on the ballot.

Rewarding Activity in the Network

If the Mobile Social Network is associated with a Reward and Loyalty Program then every user activity in the Mobile Social Network can be rewarded by the distribution of Reward points for each activity. At the discretion of the administrator the rewards may include:

a) One entry in a sweepstakes pool each time a user votes.

b) One entry in a sweepstakes pool for forwarding a ballot to a user who has not yet voted on the ballot.

c) Reward points each time a user votes on a ballot.

d) Reward points for forwarding a ballot to a user who has not yet voted on the ballot.

For example, a user may receive 50 Reward points each time he/she casts a vote and each time he/she forwards a new message to a buddy. A user may have an account with the system for storing Reward points issued to the user. Reward points accumulate in the user account and may be either redeemed for Prizes through a prizing catalog associated with the system or may be converted into credits which can then be used for activities in the network, e.g., for paying off their phone bill, or for topping up a prepaid card.

Further details on Reward and Loyalty Programs can be found, for example, in U.S. application Ser. No. 11/382,896, titled “System and Method for Mobile Loyalty Program,” filed on May 11, 2006, the specification of which is incorporated herein by reference.

Enhancing Mobile Social Network Through Voting

By combining voting with Mobile Social Networks, the user experience is enhanced. In addition, because like people usually vote similarly on issues, information collected by the system though voting can be used over time to make new connections in the Social Network.

The system tracks a user's voting record. In an offline manner, the system compares voting patterns of pairs of users and computes a Root Mean Square Error (RMSE) between their votes. This is computed offline since it can be a computationally intensive process. RMSE is computed as follows. If two users vote similarly on an item then the error is 0. If they vote differently then the error is 1. Each ballot that is voted on by both users is evaluated and the error computed on each ballot. Each of the ballot errors is squared and a total computed. The total is then divided by the number of ballots that were compared resulting in the RMSE between the two user's votes. This value is between 0 and 1.

Two system level thresholds are configured and are used to categorize the correlations. A Similar User Threshold is used to categorize all pair of users who vote similarly. For example, assuming the Similar User Threshold is 0.25, all pair of users for whom computed RMSE is below 0.25 vote similarly. Those pairs will be classified as “Like Voters”. A Dissimilar User Threshold is used to categorize users who vote very differently from each other. For example, assuming the Dissimilar User Threshold is 0.75, all pair of users who have a RMSE greater than 0.75 will be categorized as “Opposite Voters”.

In an offline manner, after a number of votes have been cast on different topics, the system determines RMSE of pair of users and using the above described thresholds categorizes the relationships between users. Visually one can imagine each “Like Voter” pair being labeled through one color arc (say green) between two users and “Opposite Voter” pair being labeled through another color (say red) between the users. In such a manner the system creates a Voting Pattern social network.

A user is allowed to browse through public information of other users with whom the user shares either “Like Voter” (green connection) or “Opposite Voter” (red connection) relationships. Through such browsing the user may discover new friends and develop new buddy relationships. This serves to further strengthen the social network.

Although the present invention has been described in terms of the presently preferred embodiments, it is to be understood that the disclosure is not to be interpreted as limiting. Various alterations and modifications will no doubt become apparent to those skilled in the art after having read this disclosure. Accordingly, it is intended that the appended claims be interpreted as covering all alterations and modifications as fall within the spirit and scope of the invention.

1. In a mobile social network comprising a plurality of mobile users, a method of community based voting comprising:
creating a voting ballot message comprising a voting ballot;
sending the voting ballot message to a mobile device of at least one user in the social network; and
receiving a vote on the voting ballot from a mobile device of at least one user in the social network.

2. The method of claim 1, wherein each user in the social network is connected to at least one other user in the social network by a buddy relationship.

3. The method of claim 2, further comprising:
creating a user profile for each user;
in each user profile, storing users with whom the corresponding user has buddy relationships.

4. The method of claim 1, further comprising:
creating a user profile for each user in the social network;
storing user attributes in each user profile;
creating ballot attributes for the voting ballot;
comparing the ballot attributes with the user attributes in each user profile; and
determining to which users to send the voting ballot message based on the comparison.

5. The method of claim 4, wherein the user attributes in each user profile comprises an age of the corresponding user, and the ballot attributes comprise a targeted age range.

6. The method of claim 1, further comprising:
publishing the vote received from the at least one user to mobile devicess of other users in the social network, wherein the vote is published with an identify of the user who made the vote.

7. The method of claim 3, further comprising:
publishing the vote received from the at least one user to mobile devices of users with whom the user has buddy relationships, wherein the vote is published with an identify of the user who made the vote.

8. The method of claim 1, further comprising:
enabling the at least one user who received the voting ballot message to forward the voting ballot message to mobile devices of other users in the social network; and
receiving a vote on the voting ballot from a mobile device of a user to whom the voting ballot message was forwarded.

9. The method of claim 1, further comprising:
receiving votes from mobile devices of the users in the social network;
for each pair of users, comparing the votes received by the pair of users; and
for each pair of users, classifying the pair of users based on the comparison.

10. The method of claim 9, further comprising:
for each pair of users, determining whether the pair of users have similar voting patterns based on the comparison; and
for each user, publishing users with whom the user has similar voting patterns to a mobile device of the user.

11. The method of claim 1, wherein the mobile device comprises a cellular phone.

12. The method of claim 1, further comprising providing a link in the voting ballot message to media content on a server, wherein when the voting ballot message is opened on a mobile device of a user, the media content is downloaded from the server to the mobile device.

13. The method of claim 12, wherein the media content comprises audio or video content.

14. A method of messaging in a mobile network comprising:
creating a message comprising an actionable item;
sending the message to a mobile device of at least one user in the mobile network;
receiving a request from a mobile device of at least one user based on action taken by the user on the actionable item; and
responding to the received request.

15. The method of claim 14, wherein the actionable item is to purchase an item, and the request is to purchase the item.

16. The method of claim 15, further comprising charging the user for the purchased item in response to the received request.
